(19) United States
(12) Patent Application Publication
(10) Pub. No.: US 2006/0065303 A1
(43) Pub. Date: Mar. 30, 2006

(54) Tank safety valve

(76) Inventor: Clyde D. Atkins SR., Conneaut, OH (US)

Correspondence Address: D.A. STAUFFER PATENT SERVICES LLC, 1006 MONTFORD ROAD, CLEVLAND HTS., OH, 44121-2016, US

(21) Appl. No.: 11/032,967

(22) Filed: Jan. 11, 2005

Related U.S. Application Data
(60) Provisional application No. 60/613,324, filed on Sep. 27, 2004.

(51) Int. Cl. F16K 17/40

(52) U.S. Cl. 137/68.11

(57) ABSTRACT

A safety valve for a tank of a pressurized gas provides a check valve that shuts off gas flow from the tank if the shutoff valve receives a damaging lateral impact. The safety valve is retrofittable in existing tanks with existing shutoff valves, wherein the shutoff valve is unscrewed from the tank and screwed into the top of the safety valve, and the bottom of the safety valve is screwed into the tank. The safety valve features a breakaway stem that sacrificially breaks more easily than the remainder of the safety valve and the shutoff valve in response to a damaging lateral impact. When the breakaway stem is broken, the check valve shuts off gas flow from the tank. The breakaway stem can be replaced with a new breakaway stem without losing the pressurized gas remaining in the tank, thereby returning the tank to normal use after the breakage.

### CROSS-REFERENCE TO RELATED APPLICATIONS

This application claims the benefit of U.S. Provisional Patent Application No. 60/613,324; filed Sep. 27, 2004 by Clyde D. Atkins, Sr.

### TECHNICAL FIELD OF THE INVENTION

The present invention relates to tanks containing pressurized gases and, more particularly, to shutoff and/or check valves for said tanks.

### BACKGROUND OF THE INVENTION

A gaseous substance (e.g., oxygen) is generally contained (stored) in a tank wherein a significant quantity of the substance can be stored by pressurizing the substance to a high pressure. In some cases (e.g., LP, liquefied propane), the pressures are high enough to turn at least a portion of the contained substance from the gas phase into the liquid phase. Very high pressures are commonly used, therefore specially shaped, thick walled metal “cylinders” are used, and the gas is discharged through a shutoff valve that is screwed into the top opening of the tank. Generally the user will add a pressure regulator in order to help control the discharge flow rate.

Thus gas cylinders (tanks) can be tantamount to bombs or missiles if mishandled. In particular, if the shutoff valve is broken, then the resulting high pressure outflow can ignite a fire or explosion (especially if the gas is flammable or oxidizing), cause damage to anything the high velocity gas jet impacts, and/or can serve as a rocket engine to propel the tank like a missile. Because of these dangers, tanks being transported typically have an inverted cup-shaped metal valve cover that screws onto the tank, protectively covering the shutoff valve. Alternatively, the tank may have a collar surrounding and protecting the valve from lateral impact (e.g., as on common LP tanks for barbeque grills). Also, when stored or in use, tanks are generally chained or otherwise secured to or within a stable structure to prevent them from falling over.

Gas tanks typically are long cylinders with the shutoff valve attached to one of the longitudinal ends, generally by screwing into a female threaded opening in the otherwise closed tank. To help prevent the abovedescribed safety hazards if the tank falls over, is dropped, or otherwise impacted in a way that breaks the shutoff valve (e.g., a lateral impact on the shutoff valve), it would be good to have a backup safety valve (check valve) that is protected from simultaneous damage and that will very rapidly check the flow of gas exiting the tank through a damaged valve. It is an object of the present invention to provide a tank safety valve that meets this need, and that can be retrofitted to existing tanks. Other objects of the invention will become apparent in light of the following description.

### BRIEF SUMMARY OF THE INVENTION

According to the invention a tank safety valve is disclosed for pressurized gas tanks that comprise a tank portion, a tank opening, and a shutoff valve attached within the tank opening, the tank safety valve comprising an undercut for controlling the location of a break in the shutoff valve resulting from a lateral impact. Preferably the tank safety valve further comprises: a breakaway stem having the undercut; a check valve between the undercut and the tank; and assembly provisions for attaching the tank safety valve within the tank opening and for attaching the shutoff valve within the tank safety valve.

According to the invention the tank safety valve further comprises a hold-open rod between the check valve and the shutoff valve; wherein: the hold-open rod is dimensioned to hold the check valve open when the tank safety valve and the shutoff valve are assembled and unbroken, and to allow the check valve to close when the breakaway stem is broken. Preferably the tank safety valve further comprises a longitudinal fin laterally extending from the hold-open rod; and a prong extending vertically between the fin and the shutoff valve. Further preferably the tank safety valve further comprises a poppet and a valve seat; and a spring biasing the poppet toward the valve seat.

According to the invention the tank safety valve is such that the breakaway stem portion sealingly mates with the check valve portion. Preferably the tank safety valve is further such that the breakaway stem portion sealingly mates with the check valve portion using a seal-first type of coupling. Further preferably the seal-first coupling comprises: a seal-first portion of the breakaway stem that comprises a threaded shank above a smooth shank; a correspondingly mating seal-first portion of the check valve that comprises a threaded throat above a smooth throat; and a sliding gasket that is captured in a groove such that the sliding gasket is sealingly compressed between the smooth shank and the smooth throat.

According to the invention the tank safety valve further comprises a shoulder on the hold-open rod; and a rod capture ridge in an inner bore of the breakaway stem portion, located between the shoulder and the undercut.

According to the invention the tank safety valve further comprises three circumferentially spaced longitudinal fins laterally extending from the hold-open rod; and a prong extending vertically between each of the fins and the shutoff valve.

According to the invention, a method is disclosed for stopping gas leakage from pressurized gas tanks that comprise a tank portion, a tank opening, and a shutoff valve attached within the tank opening; the leakage being initiated by a damaging lateral impact to the shutoff valve; the method comprising the step of controlling the location of a break in the shutoff valve resulting from the lateral impact. Preferably the method further comprises the steps of: providing a retrofittable tank safety valve that comprises a breakaway stem having an undercut for controlling the break location and a check valve between the undercut and the tank; and attaching the tank safety valve within the tank opening and attaching the shutoff valve within the tank safety valve. Further preferably the method further comprises the step of: using a hold-open rod that holds the check valve open when the tank safety valve and the shutoff valve are assembled and unbroken, and allows the check valve to close when the breakaway stem is broken. Further preferably the method further comprises the step of shaping the hold-open rod such that it minimizes interference with gas flow through the safety valve and out into the shut-off valve.

According to the invention, the method further comprises the step of biasing the check valve toward sealing closure.

According to the invention, the method further comprises the step of sealingly mating the breakaway stem portion with the check valve portion. Preferably the method further comprises the step of sealingly mating the breakaway stem portion with the check valve portion such that the breakaway stem portion seals with the check valve portion before the two portions are completely mated.

According to the invention, the method further comprises the step of constructing the safety valve such that the hold-open rod is prevented from coming out of the safety valve while the breakaway stem portion is mated with the check valve portion.

Other features and advantages of the invention will become apparent in light of the following description.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1A is a side view of a gas tank with a shutoff valve, according to the prior art;

FIG. 1B is a side view of the shutoff valve of FIG. 1A, according to the prior art;

FIG. 2A is a side cross-sectional view of the inventive safety valve retrofitted between the prior art tank and shutoff valve of FIG. 1A, according to the invention;

FIG. 2B is a side cross-sectional view of the inventive safety valve of FIG. 2A after the safety valve has been broken, according to the invention;

FIG. 3 is a side view, partially cut out, of a breakaway stem portion of the safety valve of FIG. 2A, according to the invention;

FIG. 4 is a side cross-sectional view of a check valve portion of the safety valve of FIG. 2A, according to the invention;

FIG. 5A is a side view of a hold-open rod portion of the safety valve of FIG. 2A, according to the invention;

FIG. 5B is a top cross-sectional view of the hold-open rod of FIG. 5A, the view taken along the 5B-5B line of FIG. 5A, according to the invention; and

FIG. 6 is a side view of a poppet portion of the safety valve of FIG. 2A, according to the invention.

### DETAILED DESCRIPTION OF THE INVENTION

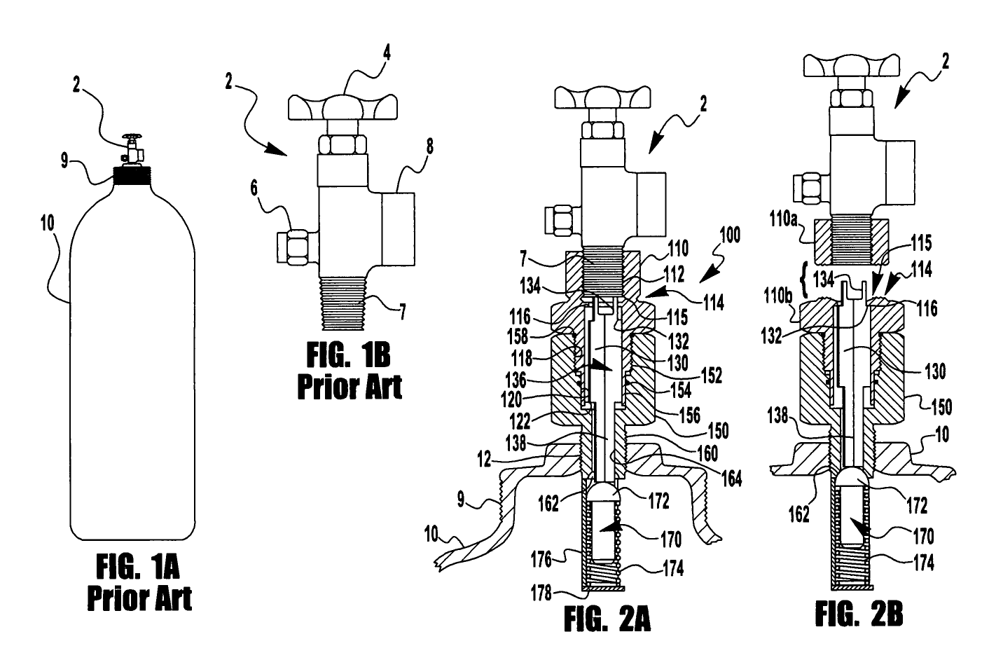

Referring to FIGS. 1A and 1B, a typical prior art gas cylinder (tank) 10 is shown with a typical prior art shutoff valve 2. The shutoff valve 2 is a manual screw-type valve that controls whether or not gas (e.g., oxygen) flows out of the tank 10, through the shutoff valve 2, and then out of the valve's outlet 8. The pressure at the outlet 8 can be measured by a pressure gauge (not shown) that can be attached in place of a plug on an optional pressure gauge port 6. The shutoff valve 2 will also roughly control gas flow according to how far the shutoff valve 2 is opened by turning a handle 4, but typically the outlet 8 is connected to an outlet line (not shown) that has some form of regulator or flow controller (not shown) for more effective and accurate flow control.

Gas tanks 10 filled with a gas are typically sold and shipped with the shutoff valve 2 attached to one of the longitudinal ends, generally by screwing a male pipe threaded inlet 7 (e.g., ¾-16 threaded) into a female pipe threaded tank opening (12 as seen in FIG. 2A). Threads 9 on the outside of the tank top are shown that are used to secure an inverted cup-shaped metal valve cover (not shown) that screws onto the tank 10, protectively covering the shutoff valve 2.

Although the shutoff valve 2 on the tank 10 is protected during shipping and storage by the valve cover, the valve cover must be removed in order to connect and use an outlet line. FIGS. 2A and 2B show an inventive tank safety valve 100 that can be retrofitted to a prior art tank 10 by screwing a male pipe threaded shank 160 into the tank opening 12, and screwing the shutoff valve 2 into a female pipe threaded opening 112 at the top of the safety valve 100. Of course the invention is not limited to pipe threaded connections, and can be adapted to many different types of connections, including, for example, gasketed straight threads, welded, etc. Obviously the retrofitting process is generally done on an empty tank 10 since the shutoff valve 2 must be removed from the tank 10.

A key feature of the inventive safety valve 100 is a breakaway stem 110 that has a breakaway groove 114 as an undercut that purposely forms a weak spot in the combined safety valve 100 and tank shutoff valve 2 such that a lateral impact on the tank shutoff valve 2 will cause the safety valve 100 to break apart (ring-off) at the breakaway groove 114 as illustrated in FIG. 2B. The stem 110 wall thickness at the breakaway groove 114 can be minimized by optionally cutting an inside breakaway groove 115 that is aligned with the breakaway groove 114. The breakaway groove(s) 114, 115 encircle the breakaway stem 110 below the threaded opening 112. Preferably the breakaway groove(s) 114, 115 are V-shaped with a sharply pointed vertex for encouraging a clean ring-off of the shutoff valve 2 and an upper part 110a of the safety valve 100 from a lower part 110b of the safety valve 100.

An important feature of the safety valve 100 is a check valve 150 in the lower portion of the safety valve 100, between the breakaway groove 114 and the tank 10. In the illustrated embodiment, the check valve 150 includes a poppet 170 that is biased by a spring 174 toward a sealing check valve seat 162. The poppet 170 is pushed away from the check valve seat 162 by a hold-open rod 130 that is in turn pushed down by the shutoff valve inlet 7 when the shutoff valve 2 and the safety valve 100 are assembled as shown in FIG. 2A. It can be seen (e.g., in FIG. 2B) that when the safety valve 100 is broken apart (preferably at the breakaway groove 114) then the hold-open rod 130 is released, thereby allowing the check valve 150 to close, shutting off all gas outflow from the tank 10 when a poppet head 172 of the spring biased poppet 170 seals against the check valve seat 162.

In an enhancement of the safety valve 100, the safety valve is made as an assembly of two portions: the breakaway stem 110 and the check valve 150. This allows a broken breakaway stem 110 (i.e., broken into an upper part 110a and a lower part 110b) to be removed from the check valve 150 and from the shutoff valve 2, and then replaced by a new breakaway stem 110. The mating portions of the breakaway stem 110 and the check valve 150 incorporate a “seal-first” type of coupling. Thus, if the shutoff valve 2 is first sealingly screwed into the opening 112 of the breakaway stem 110, then as the breakaway stem 110 is screwed into the check valve 150 the shutoff valve 2 begins to push down on the hold-open rod 130 (thereby pushing open the check valve poppet 170) as the parts are being screwed together. Because of the seal-first feature, the breakaway stem 110 is already hermetically sealed to the check valve 150 before the breakaway stem 110 is screwed into the check valve 150 far enough to push open the check valve 150 (i.e., the poppet 170).

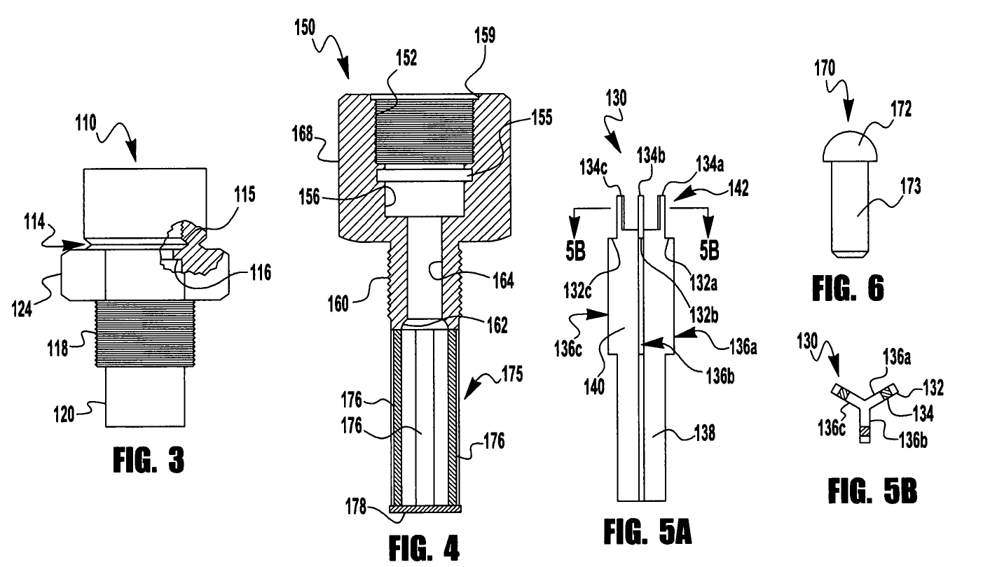

Referring to FIGS. 2A, 3 and 4, an embodiment of the seal-first coupling is illustrated. The seal-first portion of the breakaway stem 110 comprises a threaded shank 118 above a smooth shank 120, and the corresponding mating portion of the check valve 150 comprises a threaded throat 152 above a smooth throat 156. The shanks 118, 120 are close-fitting in their corresponding throats 152, 156, respectively. Furthermore, a sliding gasket 154 (e.g., an o-ring) is captured in a sliding gasket groove 155 and is dimensioned such that the sliding gasket 154 is sealingly compressed between the smooth throat 156 and the smooth shank 120, thereby hermetically sealing the breakaway stem 110 to the check valve 150 (hermetically sealing the safety valve 100). Also, the sliding gasket groove 155 is vertically positioned such that the safety valve 100 is hermetically sealed “first”, before the check valve 150 is pushed open. Furthermore, to prevent high pressure blow-off of the breakaway stem 110 while it is being mated with the check valve 150, the valve parts are dimensioned such that the threaded shank 118 is adequately screwed into the threaded throat 152 before the check valve 150 is pushed open. Preferably a second sealing gasket 158 is provided (e.g., an o-ring in a gasket groove 159) such that it is sealingly compressed between the breakaway stem 110 and the check valve 150 when they are completely screwed together. Preferably the external body 124 of the breakaway stem 110, and the external body 168 of the check valve 150 are square or hex shaped to facilitate the use of wrenches for tightly assembling the various parts. Only one possible embodiment of a seal-first coupling has been described. Of course there are many ways to form a seal-first coupling, and all forms of a seal-first coupling are intended to be within the scope of the present invention.

The preferred embodiment of the check valve 150 uses the illustrated poppet 170 that is spring biased for sealingly closing, but is held open by the hold-open rod 130. It is within the scope of the invention to incorporate any type of check valve that can be held open (i.e., prevented from closing) by a functional equivalent of the hold-open rod 130. For example, the poppet 170 could be replaced by a ball in a cage (not illustrated), with or without a spring bias. Even without a spring bias, if caged near the valve seat 162, the ball would likely be blown/sucked into the valve seat 162 by rapidly exiting gas when the safety valve 100 is broken and releases the hold-open rod 130. It is also within the scope of the invention to use any type of check valve without the hold-open rod 130 as long as the breakaway stem 110 is utilized. In the previous example comprising a ball in a cage, as long as the tank is used with the check valve in a vertical orientation, gravity will function equivalently to the hold-open rod 130. In another example, an excessive-flow-triggered check valve (not shown) could be used in conjunction with the breakaway stem 110 because the breakaway stem 110 will cause a triggering event of high flow in case of almost any lateral impact on the shutoff valve 2, whereas without the breakaway stem 110 many lower magnitude lateral impacts could cause a leak of the shutoff valve 2 that is significant, but not having a high enough flow to trigger closing of the excessive-flow-triggered check valve. In this example, the functional equivalent of the hold-open rod 130 is whatever part of the excessive-flow-triggered check valve holds the valve open when there is not an excessive flow.

With reference to FIGS. 2A through 6, further details of the check valve 150 and the hold-open rod 130 will be described. The poppet 170 has a stem 173 that fits within the bias spring 174, and a head 172 that rests on top of the bias spring 174 and is shaped to sealingly mate with the valve seat 162. For example, the poppet head 172 is semi-spherical, and the valve seat 162 is annular with a mating semi-spherical sealing surface. The bias spring 174 and the poppet 170 are contained in a suitable cage 175 that comprises, for example, a bottom 178 and slats 176 (e.g., three slats) uniformly spaced around the perimeter of the cage 175. The cage slats 176 and bottom 178 can be welded together, assembled with the bias spring 174 and poppet 170 inside, and then the slats 176 can be welded to the bottom of the check valve threaded shank 160. The cage 175 must be sized to pass through the tank opening 12. Cage slats 176 are used rather than a solid cylinder in order to allow gas in the tank 10 to flow between the slats 176 and over the poppet head 172 to exit the tank through a shank throat 164 of the safety valve 100.

Gas exiting through the safety valve 100 must also be able to freely pass around the hold-open rod 130 and out through the center hole (not shown) in the valve inlet 7. Therefore, the hold-open rod 130 has fins 136, for example a first fin 136a, a second fin 136b, and a third fin 136c. The fins 136 are uniformly spaced around the hold-open rod 130 to form a cylindrical outer periphery having a diameter that is slightly less than the inside diameter of the passageways that it passes through, thereby enabling a slidable fit. Thus a narrow portion 138 of the fins 136 slidably fits within a shank throat 164, and a wide portion 140 slidably fits within an inner bore 122 of the breakaway stem 110. Preferably, the hold-open rod 130 is confined within the assembled safety valve 100 by also providing a narrow top portion 142 that slidably fits within an annular rod capture ridge 116. A shoulder 132 on each fin 136 (e.g., a first shoulder 132a, a second shoulder 132b, and a third shoulder 132c) where the rod's diameter narrows is vertically positioned such that the shoulder 132 will hit the rod capture ridge 116 after the hold-open rod 130 has moved up enough to allow the check valve 150 to fully close. If desired, the hold-open rod 130 can be removed from the safety valve 100 by disassembling the safety valve 100, i.e., by unscrewing the breakaway stem 110 from the check valve 150. The axial center of the hold-open rod 130 is cut away at the top to leave a prong 134 (e.g., a first prong 134a, a second prong 134b, and a third prong 134c) extending upward from each fin 136. This allows gas to flow around the fins 136, then between the prongs 134, and finally out through the center hole (not shown) of the valve inlet 7. It is within the scope of the invention to incorporate any functional equivalent of the hold-open rod 130, including for example, a hollow tubular rod with lateral passages at the end touching the check valve (e.g., the poppet head 172).

In summary, an inventive safety valve 100 for a tank 10 of a pressurized gas provides a check valve 150 that shuts off gas flow from the tank 10 if the tank shutoff valve 2 receives a damaging lateral impact. The safety valve 100 is retrofittable in existing tanks 10 with existing shutoff valves 2, wherein the shutoff valve 2 is unscrewed from the tank 10 and screwed into the top 112 of the safety valve 100, and the bottom 160 of the safety valve 100 is screwed into the tank 10. The safety valve 100 features a breakaway stem 110 that sacrificially breaks more easily than the remainder of the safety valve 100 and the shutoff valve 2 in response to a damaging lateral impact. When the breakaway stem 110 is severed (broken), the check valve 150 shuts off gas flow from the tank 10. The breakaway stem 110 can be replaced with a new breakaway stem 110 and shutoff valve 2 without losing the pressurized gas remaining in the tank 10, thereby returning the tank 10 to normal use after the breakage.

In a preferred embodiment, the check valve is a spring 174 biased poppet 170 that is held open by a hold-open rod 130 that is forced against the spring bias by the shutoff valve 2 when it is screwed into the safety valve 100. The hold-open rod 130 has fins 136 and prongs 134 to allow minimally restricted flow of gas out of the tank 10, through the check valve 150 and the breakaway stem 110, and then out through the prior art shutoff valve 2. The breakaway stem 110 preferably comprises at least one external V-shaped groove 114 encircling the stem 110 as an undercut that provides a weakened wall for a preferred ring-off breaking line between the shutoff valve 2 and the check valve 150.

Although the invention has been illustrated and described in detail in the drawings and foregoing description, the same is to be considered as illustrative and not restrictive in character it being understood that only preferred embodiments have been shown and described, and that all changes and modifications that come within the spirit of the invention are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A tank safety valve for pressurized gas tanks that comprise a tank portion, a tank opening, and a shutoff valve attached within the tank opening, the tank safety valve comprising:
an undercut for controlling the location of a break in the shutoff valve resulting from a lateral impact.

2. The tank safety valve of claim 1, further comprising:
a breakaway stem having the undercut;
a check valve between the undercut and the tank; and
assembly provisions for attaching the tank safety valve within the tank opening and for attaching the shutoff valve within the tank safety valve.

3. The tank safety valve of claim 2, further comprising:
a hold-open rod between the check valve and the shutoff valve; wherein:
the hold-open rod is dimensioned to hold the check valve open when the tank safety valve and the shutoff valve are assembled and unbroken, and to allow the check valve to close when the breakaway stem is broken.

4. The tank safety valve of claim 3, further comprising:
a longitudinal fin laterally extending from the hold-open rod; and
a prong extending vertically between the fin and the shutoff valve.

5. The tank safety valve of claim 3, wherein the check valve further comprises:
a poppet and a valve seat; and
a spring biasing the poppet toward the valve seat.

6. The tank safety valve of claim 3, wherein:
the breakaway stem portion sealingly mates with the check valve portion.

7. The tank safety valve of claim 6, wherein:
the breakaway stem portion sealingly mates with the check valve portion using a seal-first type of coupling.

8. The tank safety valve of claim 7, wherein the seal-first coupling comprises:
a seal-first portion of the breakaway stem that comprises a threaded shank above a smooth shank;
a correspondingly mating seal-first portion of the check valve that comprises a threaded throat above a smooth throat; and
a sliding gasket that is captured in a groove such that the sliding gasket is sealingly compressed between the smooth shank and the smooth throat.

9. The tank safety valve of claim 6, further comprising:
a shoulder on the hold-open rod; and
a rod capture ridge in an inner bore of the breakaway stem portion, located between the shoulder and the undercut.

10. The tank safety valve of claim 6, further comprising:
three circumferentially spaced longitudinal fins laterally extending from the hold-open rod; and
a prong extending vertically between each of the fins and the shutoff valve.

11. A method for stopping gas leakage from pressurized gas tanks that comprise a tank portion, a tank opening, and a shutoff valve attached within the tank opening; the leakage being initiated by a damaging lateral impact to the shutoff valve; and the method comprising the step of:
controlling the location of a break in the shutoff valve resulting from the lateral impact.

12. The method of claim 11, further comprising the steps of:
providing a retrofittable tank safety valve that comprises a breakaway stem having an undercut for controlling the break location and a check valve between the undercut and the tank; and
attaching the tank safety valve within the tank opening and attaching the shutoff valve within the tank safety valve.

13. The method of claim 12, further comprising the step of:
using a hold-open rod that holds the check valve open when the tank safety valve and the shutoff valve are assembled and unbroken, and allows the check valve to close when the breakaway stem is broken.

14. The method of claim 13, further comprising the step of:
shaping the hold-open rod such that it minimizes interference with gas flow through the safety valve and out into the shut-off valve.

15. The method of claim 13, further comprising the step of:
biasing the check valve toward sealing closure.

16. The method of claim 13, further comprising the step of:
sealingly mating the breakaway stem portion with the check valve portion.

17. The method of claim 16, further comprising the step of:
sealingly mating the breakaway stem portion with the check valve portion such that the breakaway stem portion seals with the check valve portion before the two portions are completely mated.

18. The method of claim 16, further comprising the step of:
constructing the safety valve such that the hold-open rod is prevented from coming out of the safety valve while the breakaway stem portion is mated with the check valve portion.
